(19) United States
(12) Patent Application Publication
(10) Pub. No.: US 2008/0087829 A1
(43) Pub. Date: Apr. 17, 2008

(54) Single-photon emission computed tomography (SPECT) using helical scanning with multiplexing multi-pinhole apertures

(76) Inventors: John Hoppin, Peaks Island, ME (US); Staf vanCauter, Guilford, CT (US); Christian Lackas, Cologne (DE); Laszlo Nagy, (US); Uwe Engeland, Goettingen (DE)

Correspondence Address: BINGHAM MCCUTCHEN LLP, 2020 K Street, N.W., Intellectual Property Department, WASHINGTON, DC, 20006, US

(21) Appl. No.: 11/783,738

(22) Filed: Apr. 11, 2007

Related U.S. Application Data
(60) Provisional application No. 60/790,829, filed on Apr. 11, 2006.

(51) Int. Cl. G01T 1/00

(52) U.S. Cl. 250/363.04

(57) ABSTRACT

The reconstruction of artifact free images is made possible by the implementation of a SPECT imaging device that employs helical scanning. The SPECT imaging device includes a detector configured to detect photons, such as photons, that are projected onto it. A collimator is axially aligned with the detector and includes a plurality of pinholes configured to create overlapping projections of the photons. An object support structure is configured to move in a direction that is axially aligned with the detector and collimator. The detector and collimator are configured to rotate around the object support structure in a transaxial plane to the object support structure while the object support structure moves in an axial direct to the collimator and detector.

### FIELD OF THE INVENTION

The present invention relates to SPECT imaging using multi-pinhole apertures with overlapping projections from each pinhole in the transaxial and axial directions.

### BACKGROUND OF THE INVENTION

SPECT technology is used in the medical field for performing such tasks as animal research, preclinical research, and patient diagnosis. Typically, radioisotopes are administered to an object of interest, such as an animal or human. The administered radioisotopes emit energy in the form of radiation that can be detected. The spatial distributions of the radioisotopes in the object of interest can be determined from the detected radioisotopes. Based on the distribution of the radioisotopes in the object, various diagnoses can be made about the object.

Various types of SPECT imaging devices have been developed for the purpose of detecting radioisotopes administered to an object. The most recent SPECT imaging devices implement a multiplexing multi-pinhole aperture. Multi-pinhole apertures were introduced into SPECT imaging in an attempt to increase the efficiency (sensitivity) of the imaging device without loss of image resolution. This increase is further improved by allowing the projection from each pinhole in the multi-pinhole aperture to overlap (multiplexing) on the detector of the SPECT imaging device. These SPECT imaging devices can find application in pre-clinical research, such as the examination of small animals in the development and evaluation of innovative trace compounds and can even be extended to smaller field of view imaging in the clinic, e.g. extremities, thyroid, brain, cardiac, etc.

However, the overlapping projections created by the pinholes of these high-resolution, high-sensitivity SPECT imaging devices introduce sampling singularities which in turn can result in image artifacts. Specifically, if a region of an object was projected exclusively to a region of overlap on the detector, this would introduce a null component (singularity) into the imaging system. The existence of these object dependent null components in turn lead to a decrease in reconstruction quality and in some cases image artifacts (FIGS. 1 & 2). A reconstruction artifact is an impurity in the reconstructed image caused by one of a variety of effects, e.g. poor system modeling, detector failure, a large amounts of activity outside the field of view, null component in the imaging system, etc. One approach to quantifying artifacts mathematically is to calculate a mean-squared error between the true object and the reconstructed object (FIG. 1c). Note this is only possible if the true object is known, as is the case in a simulation.

Image overlap can be quite extensive in the transaxial direction. In general, considerable overlap in the transaxial direction is acceptable as a SPECT camera consists of gamma cameras mounted on a rotating gantry. This rotation provides a means by which the overlap in the transaxial direction can be properly deconvolved.

FIG. 1A is a schematic diagram of a prior art SPECT imaging device using a multi-plexing multipinhole aperture. The SPECT imaging device 100 includes a detector 102, and a multi-pinhole aperture 104 (collimator). In FIG. 1A the aperture is a 3 pinhole aperture having pinholes 106A-106C. Object 108 is an object of interest being examined by imaging device 100. Single photons emitted from the object pass through the pinholes 106A-106C and create projections 110A-110C on detector 102. Three projections are created on the detector with two overlapping regions 112A-112B, where the percentage of overlap between the projections is defined by the tilt and opening angle of the pinholes as well as the distance between projections to be detected by a detector. There is a need for the device to perform a scan of an object of interest in transaxial direction (circular scan). There is a need for the circular scan to create overlapping projections on the detector. There is a need for the device to perform a scan of the object of interest in an axial direction (translational scan). There is a need for the translational scan to create overlapping projections on the detector. There is a need to perform circular scanning while performing translational scanning (helical scan). There is a need to maximize the overlap on the detector to decrease the acquisition times of images by increasing system sensitivity. There is a need for the helical scan to enable the production of artifact free reconstruction of the object's image when overlap on the detector is maximized.

### SUMMARY OF THE INVENTION

To improve sensitivity and resolution in SPECT imaging system a helical scan is implemented allowing an increase in overlapping projections along the axial direction of a detector. The SPECT imaging system of the present invention acquires data for an object by performing a helical scan of the object. The helical scanning of an object by a SPECT imaging system allows for artifact-free image reconstruction of said object. In addition to increased angular sampling and pinholes. These overlapped regions on the detector can potentially create null space or singularities in the imaging system and in turn result in a reconstruction of the image with artifacts. FIG. 1B shows the projections created by various multiplexing multi-pinhole aperture configurations with different percentages of overlap on the detector 102. The percentages of overlap are calculated as the percentage of overlap relative to the total area of the projections taken individually. FIG. 1C is a schematic diagram representing the effect of overlap on image reconstruction quality. The mean-squared error (MSE) between a true object and a reconstructed object is plotted as a function of the different overlap sequences presented in FIG. 1B. FIG. 1C demonstrates that as the percentage of overlap increases on a detector, the amount of artifacts introduced to a reconstructed image (mean-squared error) also increases.

FIGS. 2A-2C depict the results of reconstructions performed on a object. FIG. 2A depicts a true reconstruction image of an object. FIG. 2B depicts a reconstruction of the object using a prior art SPECT implementing only a circular scan. As shown in FIG. 2B, artifacts exist in the center area of the reconstructed image. FIG. 2C represents the removal of said artifact using a helical acquisition.

There is a need for a high-resolution, high-sensitivity SPECT imaging device (device). There is a need for the device to use multi-pinhole apertures that create overlapping projections from each pinhole. There is a need for the overlapping increased overlap allowed on the detector, helical scanning also provides a variable axial imaging range.

In an embodiment of the present invention, a SPECT imaging device using multi-pinhole apertures with overlapping projections from each pinhole in the transaxial and axial directions includes a detector configured to detect photons, a collimator with a plurality of pinholes that are configured to maximize overlapping projections of the photons, and an object support structure configured to perform helical scanning. Namely, a rotating gantry moving in sync with a translation stage to create a helical orbit of the multiplexing multi-pinhole apertures around the object.

### BRIEF DESCRIPTION OF THE DRAWINGS

The details of the present invention, both as to its structure and operation, can best be understood by referring to the accompanying drawings, in which like reference numbers and designations refer to like elements.

FIG. 1A is an exemplary schematic diagram of a prior art gamma camera for SPECT imaging using a multiplexing multi-pinhole aperture.

FIG. 1B shows the projections created by various multiplexing multi-pinhole aperture configurations with different percentages of overlap on a detector.

FIG. 1C is a schematic diagram representing the effect of overlap on image reconstruction quality.

FIG. 2A depicts a true reconstruction of an image for an object.

FIG. 2B depicts a reconstruction of the object using the prior art SPECT imaging system using circular scanning.

FIG. 2C depicts a reconstruction of the object using the SPECT imaging device using helical scanning according to the present invention.

FIG. 3A is an exemplary illustration of a SPECT imaging device using a helical scan according to the present invention.

FIG. 3B is an exemplary illustration of an imager 302 shown in FIG. 3A according to the present invention.

FIG. 4 is an exemplary diagram of a system 306 shown in FIG. 3.

FIG. 5 are exemplary illustrations of an imager and object support structure of a SPECT imaging device in operation performing a helical scan of an object of interest.

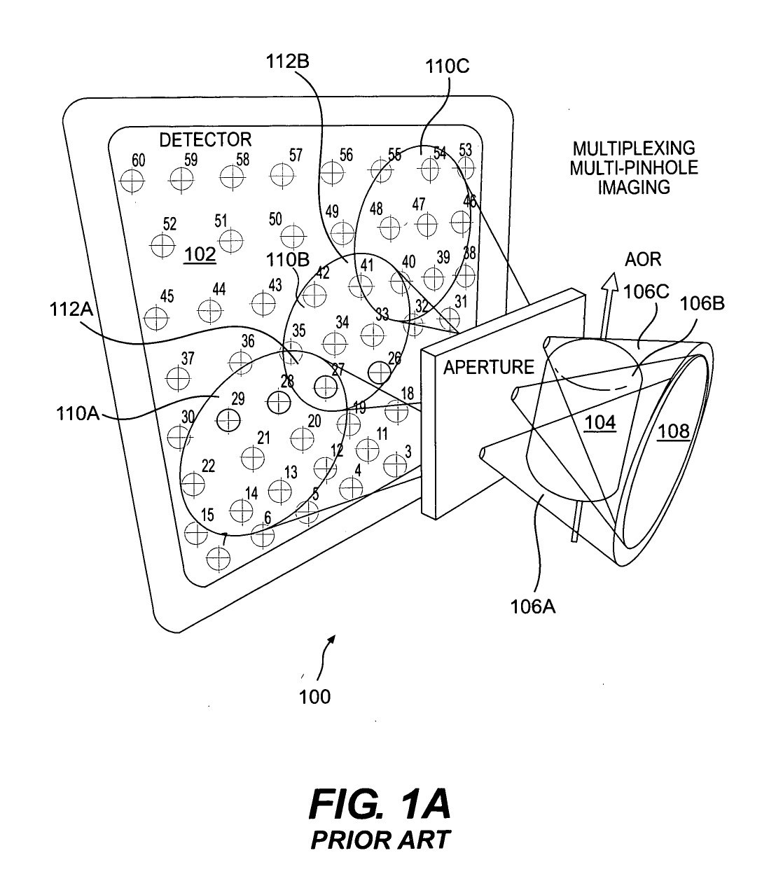

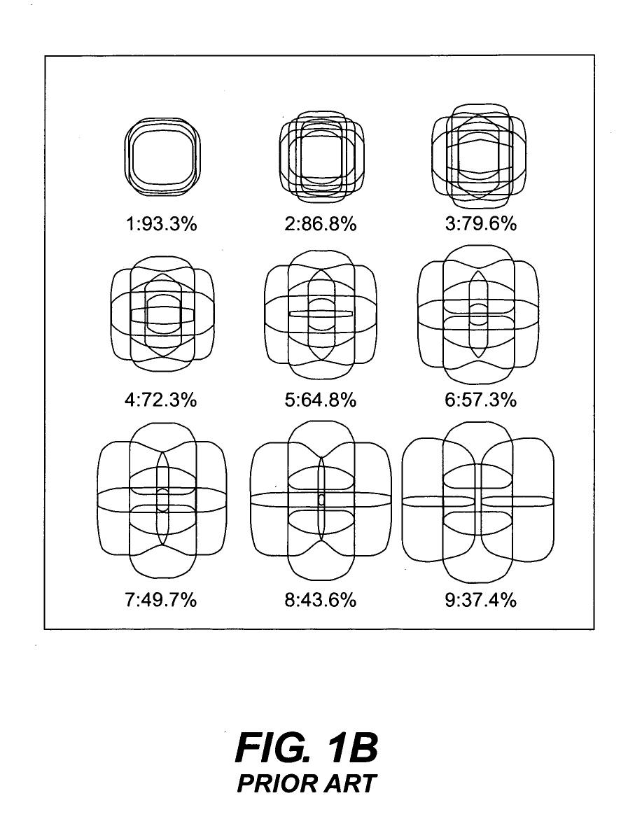

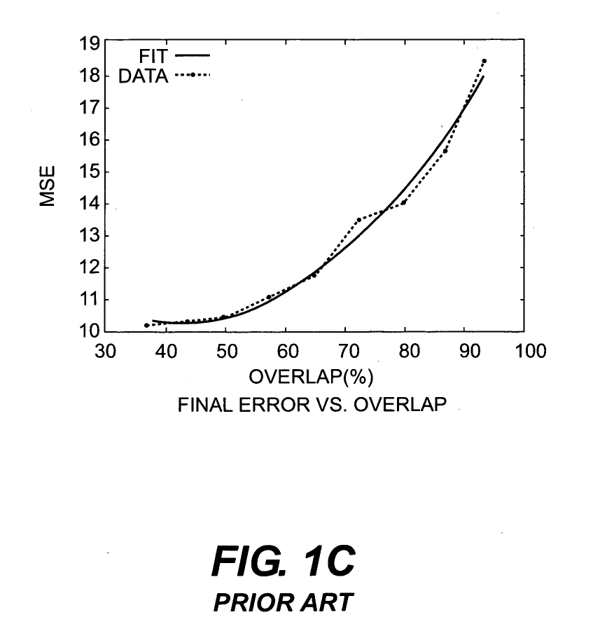

### DETAILED DESCRIPTION OF THE INVENTION

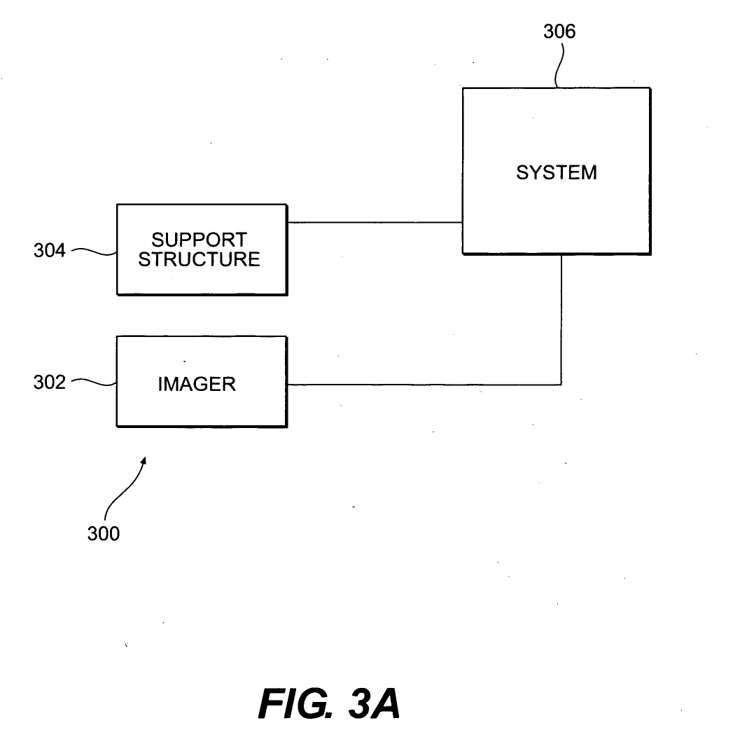

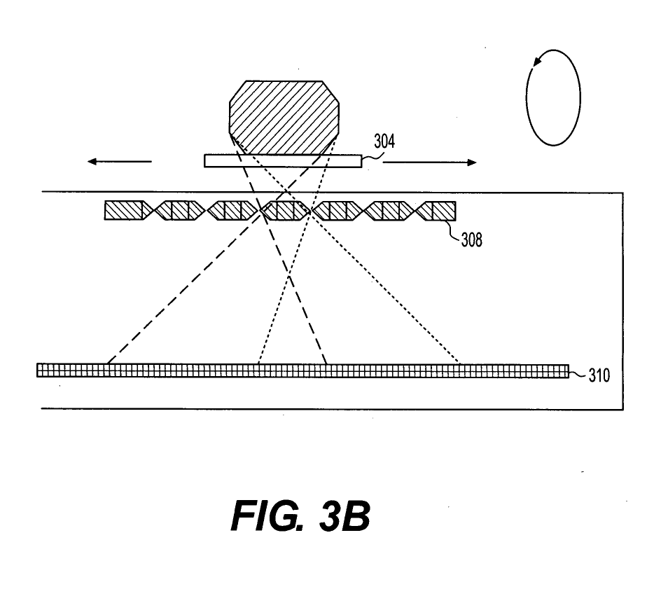

An exemplary SPECT imaging device 300, in which the present invention may be implemented, is shown in FIG. 3A. System 300 includes at least one imager 302, object support structure 304 (translation stage), and system 306. Turning here briefly to FIG. 3B. The imager 302 includes a multi-pinhole collimator 308 and a detector 310. The imager 302 is operable to rotate in the transaxial plane around an object of interest (not shown) being supported by the object support structure 304. The imager 302 can be rotated by a motor, such as a gantry, under the control of system 306. The imager 302 may be rotated a number of degrees after a projection is taken. The imager 302 can be rotated an unlimited amount either using slip-ring electronics or by using a technique by which the imager is rotated in an alternating clock-wise and counter-clockwise motion while translating the object support structure forward or backward respectively to generate a helical orbit.

In an embodiment of the present invention, the SPECT imaging device includes a plurality of imagers 302. Each of the imagers 302 can be rotated in the transaxial plane around an object being supported by the object support structure. Each of the imagers can be rotated a number of degrees after a projection shot is taken.

The collimator 308 includes a plurality of pinholes. Each of the pinholes in the plurality of pinholes on the at least one multi-pinhole collimator 304 opens into the shape of a funnel on the top and bottom surfaces of the collimator 308. Each of the pinholes is operable to allow photons emitted from radioisotopes administered to an object of interest to pass through in a conical shape. To increase the sensitivity, of the imager, the size of each pinhole can range from 0.1 mm in diameter up to 4 mm in diameter. The number of pinholes can range from 2 into the hundreds with no clear upper bound. The distance between the pinholes in the multi-pinhole collimator is selected to enable overlapping regions of an object of interest to be projected onto detector 310. Allowing overlapping regions achieves higher image resolution and sensitivity. Collimator 308 can be configure from materials including, but not limited to, tungsten, lead or any other machinable heavy alloy, on occasion outfitted with gold inserts or inserts made of other materials.

In an embodiment of the present invention, the funnel on the top surface of the collimator is smaller than the funnel on the bottom surface of the collimator. The collimator 308 is positioned between an object of interest on the object support structure 304 and the detector 310, where the top surface of the collimator 308 is facing the object of interest and the bottom surface of the collimator 308 is facing the detector 310.

The detector 310 receives photons projected from each of the pinholes on the collimator 308. The plurality of pinholes on the multi-pinhole collimator 308 can create overlapping projection created from each pinhole in the multi-pinhole collimator on the detector 310 and reproduce an enlarged image of the object of interest on the detector 310. In an embodiment of the present invention, the pinholes are configured on the collimator to provide maximum overlap of projections on the detector without introducing image artifacts. The object support structures supports an object of interest and moves the object of interest in an axial direction to the imager 302. The support structure can be moved using techniques known to those skilled in the art. In an embodiment of the present invention, the support structure is moved in an axial direction a predetermined amount. The object support structure 304 can move a total of 50 cm through the field of view of the SPECT imaging device 300. The movement of the object support structure in a transaxial plane to the collimator and detector while the collimator and detector are moving around the object support structure in a transaxial plane produces a helical scan of the object on the object support structure. In an embodiment of the present invention, the object support structure 304 moves approximately 2-5 cm during the full rotation (360 degrees) of a single imager system. In an embodiment of the present invention, a multi-imager system rotates each imager such that the collective rotation of each imager is equivalent to a 360 degree rotation of a single-detector system. The system 306 performs signal processing of the signals generated by the imager 302 and reconstruction of the object of interest's image that is artifact free.

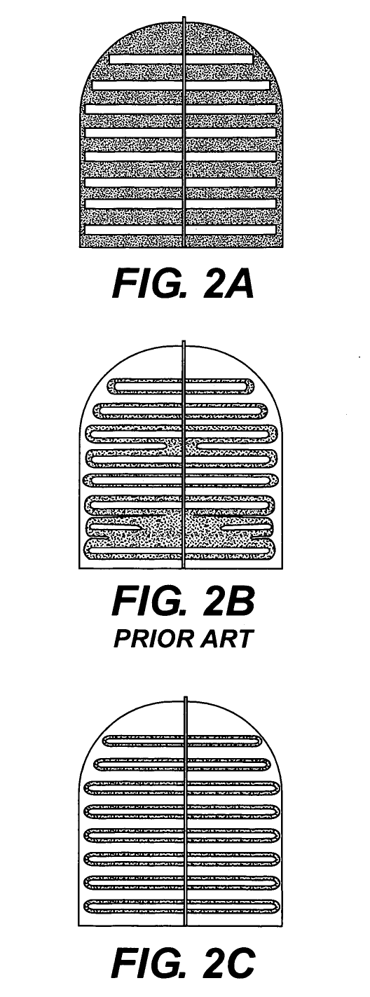

FIG. 2C depicts a reconstruction of the object using the SPECT imaging device using helical scanning according to the present invention. As shown, the reconstructed image is artifact free.

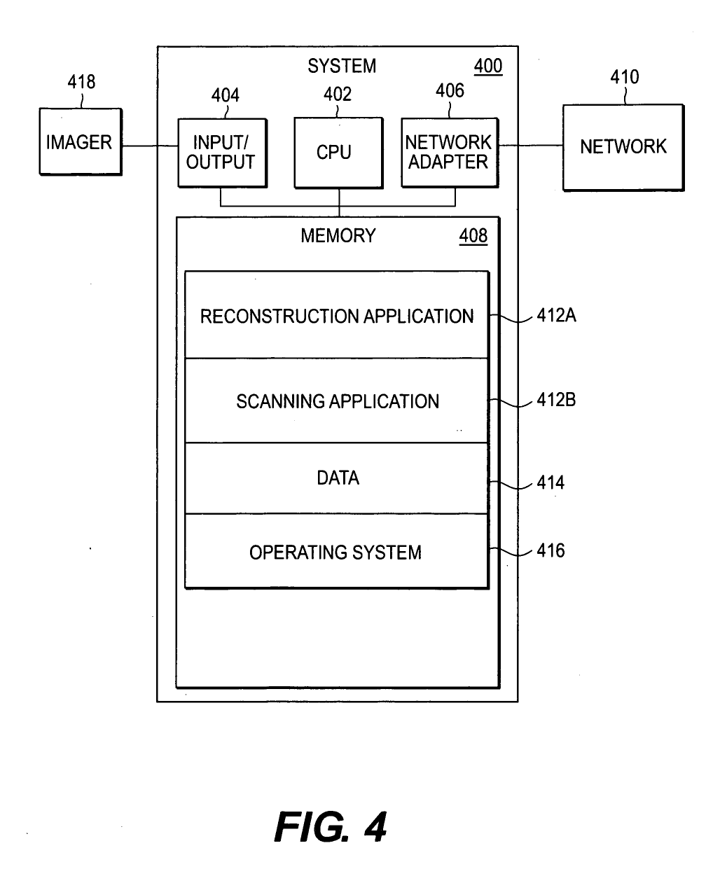

An exemplary block diagram of a system 306 is shown in FIG. 4. System 400 is typically a programmed general-purpose computer system, such as a personal computer, workstation, server system, and minicomputer or mainframe computer. System 400 includes a processors (CPU) 402, input/output circuitry 404, network adapter 406, memory 408 and imager 418. CPU 402 executes program instructions in order to carry out the functions of the present invention. Typically, CPU 402 is a microprocessor, such as an INTEL PENTIUM® processor. Imager 418

Input/output circuitry 404 provides the capability to input data to, or output data from, system 400. For example, input/output circuitry may include input devices, such as keyboards, mice, touchpads, trackballs, scanners, etc., output devices, such as video adapters, monitors, printers, etc., and input/output devices, such as, modems, etc. Network adapter 406 interfaces system 400 with Internet/intranet 410. Internet/intranet 410 may include one or more standard local area network (LAN) or wide area network (WAN), such as Ethernet, Token Ring, the Internet, or a private or proprietary LAN/WAN.

Memory 408 stores program instructions that are executed by, and data that are used and processed by, CPU 402 to perform the functions of system 400. Memory 408 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

In the example shown in FIG. 4, memory 408 includes reconstruction application 412A, scanning application 412B, data 414 and operating system 416. Application 412A is software that handles the reconstruction of images produced on the detector of the present invention. Scanning application 412B performs the function of generating projection shots of an object of interest supported on an object support structure, rotating an imager around the object of interest on the object support structure in a transaxial direction to the object support structure (helical scan), and moving the object support structure supporting the object of interest in an axial direction to the object support structure (translational scan). Operating system 514 provides overall system functionality.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

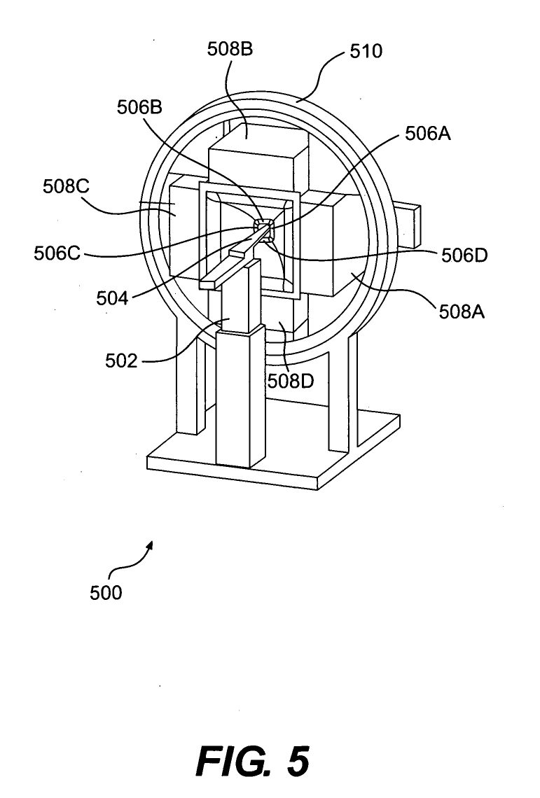

FIG. 5 is an exemplary illustration of an imager and object support structure of a SPECT imaging device in operation performing a helical scan on an object of interest. In the FIG. 5 embodiment of the present invention, the SPECT imaging system 500 is a 4 head-imager system. The SPECT imaging system includes four gamma cameras 508A-508D (detectors) housed on a gantry 510, a translation stage 504 and a lift 502 configured to move said lift 502 (object support structure) up and down and said translation stage 504 forward and backward in a axial direction to the gamma cameras and four collimators 506A-506D. In the FIG. 5 embodiment of the invention the gantry rotates the gamma cameras around the translation stage while the translation stage moves in the axial direction.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A SPECT imaging system using multi-pinhole apertures with overlapping projections from each pinhole in the transaxial and axial directions comprising:
a detector configured to detect photons;
a collimator with a plurality of pinholes that are configured to create an overlapping projections of the photons; and
an object support structure configured to move in a direction that is axially aligned with the detector and collimator;
wherein the detector and collimator are configured to rotate around the object support structure in a transaxial direction, often referred to as the transverse plane, to the object support structure.

2. The SPECT imaging system according to claim 1, wherein detected photons overlap.

3. The SPECT imaging system according to claim 1, further comprising a computer configured to rotate the collimator and detector around the object support structure.

4. The SPECT imaging system according to claim 3, wherein the computer is configured to move the object support structure in a direction axially aligned with the collimator and detector.

5. The SPECT imaging system according to claim 4, wherein the collimator and detector are rotated around the object support structure while the object support structure is moved in the direction axially aligned with the collimator and detector.

6. The SPECT imaging system according to claim 5, wherein the detector receives overlapping photons that enable artifact free reconstruction of an image.

7. The SPECT imaging system according to claim 1, further comprising an object positioned on the object support structure, wherein the object emits the photons.

8. A method of performing SPECT imaging using multi-pinhole apertures with overlapping projections from each pinhole in the transaxial and axial directions comprising the steps of:
detecting photons on a detector;
creating overlapping projections of the photons employing a collimater having a plurality of pinholes; and
moving an object support structure in a direction that is axially aligned with the detector and collimator;
rotating the detector and collimator around the object support structure in a transaxial direction to the object support structure.

9. The method according to claim 8, further comprising detecting overlapping photons.

10. The method according to claim 8, wherein the collimator and detector are rotated around the object support structure while the object support structure is moved in the direction axially aligned with the collimator and detector.

11. The method according to claim 9, wherein the overlapping photons produce artifact free reconstruction images.
